(19) United States
(12) Patent Application Publication
(10) Pub. No.: US 2008/0185930 A1
(43) Pub. Date: Aug. 7, 2008

(54) Rotor For an Electrical Machine

(76) Inventors: Dietmar Ahrens, Lahr (DE); Juergen Schuetz, Rheinau (DE); Tilo Koenig, Buehl (DE)

Correspondence Address: MICHAEL J. STRIKER, 103 EAST NECK ROAD, HUNTINGTON, NY, 11743, US

(21) Appl. No.: 11/995,831

(22) PCT Filed: Oct. 6, 2006
(86) PCT No.: PCT/EP2006/067132

§ 371 Date: Jan. 16, 2008

(30) Foreign Application Priority Data
Oct. 11, 2005 (DE) 102005048546.4

(51) Int. Cl. H02K 1/28; H02K 1/27

(52) U.S. Cl. 310/156.08

(57) ABSTRACT

The present invention relates to a rotor for an electrical machine, in particular a brushless DC motor, having a rotor body (2), which has an essentially cylindrical shape, and having at least one magnet (5) having a bearing face (6), the magnet being arranged on the circumference of the rotor body, characterized in that the rotor body (2) has at least one web (3) aligned in the longitudinal direction.

### PRIOR ART

The present invention relates to a rotor for an electrical machine, in particular a brushless DC motor, having a rotor body that has a substantially cylindrically shape, and having at least one magnet with a contact face which is located on the circumference of the rotor body.

In the majority of DC motors, the magnets are glued onto the magnetically conductive short circuit. Various shapes of magnet are known, such as shells, blocks or magnets in the shape of a D, also called “bread loaves”. The short circuits of the DC motors are either formed in one piece from steel or comprise lamination packets, formed of laminations resting on one another. The laminations may be insulated from one another or made into a packet by stamping.

The alignment of the magnets with one another on the short circuit is accomplished partly with an auxiliary adapter of plastic or with springs that assure the spacing between adjacent magnets. This plastic adapter has the task of positioning the glued-on magnets during the curing process. Those skilled in the art therefore consider the adapter a “lost part”, since it is not of significance for the function of the rotor.

As an alternative to this adapter, magnets may also be positioned or pressed against something during the curing process of the glue by means of complicated, expensive auxiliary devices. The auxiliary devices have to be removed again after the glue has cured. Depending on the glue, the curing process can take up to 24 hours. In that time, the glue must not touch the auxiliary device.

### ADVANTAGES OF THE INVENTION

The rotor according to the invention for an electrical machine having the characteristics of claim 1 has the advantage that a magnet can be secured quickly and reliably to the rotor body. A predetermined positioning can be assumed exactly and unambiguously. The position of the magnet is also maintained without further aids or tools. It is advantageous that positioning of the magnet at a precise angular position is possible with regard to other characteristics, for instance with regard to further short circuits with magnets or with regard to a sensor array. Moreover, besides unmagnetized magnets, already-magnetized magnets can be processed without being displaced by magnetic forces that occur. The rotor according to the invention with a rotor body that has a substantially cylindrical shape and with at least one magnet that is located along the circumference of the rotor body has at least one radially outward-oriented rib, which is aligned in the longitudinal direction of the rotor body. The magnet rests on the longitudinally oriented rib and is aligned by it. When rotors are manually equipped with a plurality of magnets, the rib offers an alignment aid against which the magnet can be placed. In machine and automatic equipping of rotors with magnets, the rib acts as a guide rail, which reinforces the alignment of the magnet and avoids slippage later. The rib can thus assure correct positioning of the magnet.

The dependent claims recite preferred refinements of the invention.

Especially advantageously, the rotor body has at least one receiving face for a magnet along its circumference. This receiving face is laterally defined by two ribs. The ribs are preferably likewise oriented longitudinally. A magnet is then introduced between the two ribs, oriented to both sides, and thus limited in any possible motion. This prevents the magnet from being put in a twisted position longitudinally. Depending on the desired number of magnets to be positioned, a predetermined number of receiving faces are created. The adjacent receiving faces are preferably each defined by a respective rib. Thus the entire rotor body can be embodied along the circumference with alternating receiving faces and ribs. The result is a good hold and fixation of the magnets, which is important precisely in the curing process of an adhesive applied. Complicated additional aids need not be provided for fixing the magnet, on being glued in placed, during the curing process. A simple elastic band that is fastened around the rotor is for instance sufficient for the fixation, since the magnets are held between the lateral ribs. The costs for fixation devices can accordingly be reduced markedly.

The ribs on the rotor body are located in such a way that the magnets are positioned and are kept in position. A plurality of ribs are oriented longitudinally over the entire rotor body. Even premagnetized magnets can be processed and installed in a simple way. The magnets are oriented between the ribs and simultaneously fixed. No additional aids or devices have to be used to bring about a defined spacing between two adjacent magnets.

The rotor design is accordingly based on poka-yoke principles. A magnet need merely be placed in correct, unmistakable and biunique positions. No options whatever in location, and thus no freedom of decision for an installer who has to glue the magnets to the rotor body thus arise. This leads to error-free assembly that is faster and more efficient.

Especially preferably, the spacing between two adjacent ribs is slightly greater than the width of the magnets themselves. As a result, the alignment of the magnets can be improved further. Possible positional tolerances between the individual magnets are thus reduced further, so that in the final analysis, higher quality in the production of the rotors is attained.

Also preferably, the adjacent ribs are located such that the magnets can be clipped in place between them. Securing of the magnets is done by clipping in place. The magnet stays in position even if the rotor continues to be rotated. This is especially important whenever an adhesive is applied between the magnet and the rotor. In the curing phase of the adhesive, no further provision is therefore needed to prevent slipping. This is true regardless of whether the rotor body is positioned in an oven or forced-air oven, or whether the adhesive is cured for instance by anaerobic reaction at room temperature.

Especially preferably, the ribs are formed integrally with the rotor body. In an integral embodiment, there is no risk that the ribs will break off or themselves slip in position. Separating the rib and rotor body is not possible. If the rotor body is in one piece, the interstices between ribs can be ground or milled out of the solid material. This is different from rotor bodies that comprise lamination packets which are constructed from many thin laminations lined up with one another. The laminations are produced by stamping, also called punching. Thus in a simple way, by changing the shape of the punch, the individual lamination can be changed as well. Overall, the result is a rotor body with integrally provided ribs that are not expensive, or only insignificantly expensive to produce, compared to a rotor body without ribs.

Preferably, the magnets rest on the rotor body substantially on the side regions of their contact faces. The result is two longitudinally oriented, narrow contact faces, so that the contact can be described as contact on two lines. A defined linear contact between the short circuit or rotor and the magnet is thus established. Hence the magnet rests in a well-defined way on the rotor body and cannot rock or wobble. The result is thus a gap between the receiving face of the rotor and the underside of the magnet. This gap can be used to receive adhesives.

A rotor in which the receiving face of the rotor body has a curvature that differs from the curvature of the contact face of the magnet proves especially advantageous. The two curvatures should be selected such that the magnet rests on the receiving face of the rotor body only at the peripheral regions of the contact face. Thus by a suitable choice of the curvatures, a defined gap can be produced between the rotor body and the magnet. Moreover, this also creates a defined adhesive gap, or a predetermined volume for receiving adhesive. This can be correlated with the quantity of adhesive to be applied, so that only little or even no adhesive escapes from the gap, yet large-area gluing or adhesive bonding of the magnet and rotor body occurs. Such a concept also allows a variable selection of adhesives. For instance, many adhesives can be used, such as epoxies, acrylates, silicones, or polyurethanes. The adhesive can accordingly be changed without affecting the design of the rotor body or of the magnets.

A taper is especially preferably provided on the lower end of each of the ribs. This taper can be produced for instance by being stamped out. Just above the receiving face of the rotor body, this produces a void on the lower end of the rib between the magnet and the rotor packet. In this available void, protruding edges, for instance, of sharp-edged magnets can be received. Thus the rotor with such ribs is independent of the edge radius of the magnets. Moreover, the void also forms a reserve to be able to receive excess adhesive. If the adhesive applied between the magnet and the rotor body is forced to the side as the magnet is pressed against the rotor body, then a certain quantity of adhesive can be received in this void without escaping past the rib. Hence the outer surface of the magnets or the upper end of the ribs do not become glued and hence will not stick to production equipment.

In a further preferred embodiment of the invention, the rotor body, in the peripheral region of each of the ribs, has a respective recess or depression. This depression is made on the receiving face of the rotor body. This depression again has the purpose of receiving excess adhesive in a kind of adhesive reserve. The depression on the rotor body preferably merges directly with the void at the base of the ribs.

In a further preferred feature of the invention, the ribs has a first part and a second part in the longitudinal direction of the rotor, and the first is offset from the second part in the circumferential direction of the rotor. This creates a rotor with two regions, in which the location of the ribs and magnets relative to one another is rotated somewhat. The formation of the two regions on the rotor has the advantage that detent positions of the rotor, at which the rotor can come to a stop, can be prevented. Thus in particular, a beveling of the rotor, known in the prior art, can be dispensed with. The offset location of two regions of the rotor does have the disadvantage of somewhat reduced power, but stopping of the rotor at unwanted positions can be reliably prevented.

An angle of the offset between the first part of the rib and the second part of the rib of between 0.1° and 30° is advantageous. Especially advantageously, the angle is between 5° and 20°.

### DRAWINGS

Preferred exemplary embodiments of the invention will be described in detail below in conjunction with the drawings. Shown are:

FIG. 1, a perspective view of a rotor with a magnet, in a first exemplary embodiment of the invention;

FIG. 2, a plan view on the rotor of FIG. 1, now equipped with six magnets;

FIG. 3, a detail of the rotor of FIG. 2; and

FIG. 4, a perspective view of a rotor in a second exemplary embodiment of the invention.

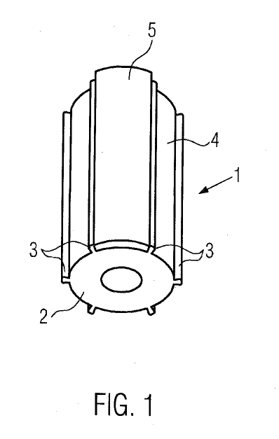

FIG. 1 shows a rotor 1 of a brushless DC motor, with a rotor body 2, in a first exemplary embodiment of the invention. The rotor body 2, along its circumference, has six ribs 3 oriented longitudinally of the rotor body 2 and distributed equidistantly over the rotor body 2. Between each two ribs 3, a receiving face 4 is embodied that serves to receive magnets 5. The magnet 5 rests on the receiving face 4 and is located between two adjacent ribs 3. The ribs 3 extend over the entire length of the rotor body 2.

The rotor 1 shown in FIG. 1 is first equipped with one magnet 5. Five further receiving faces 4 are still available and will be equipped with magnets in further work steps.

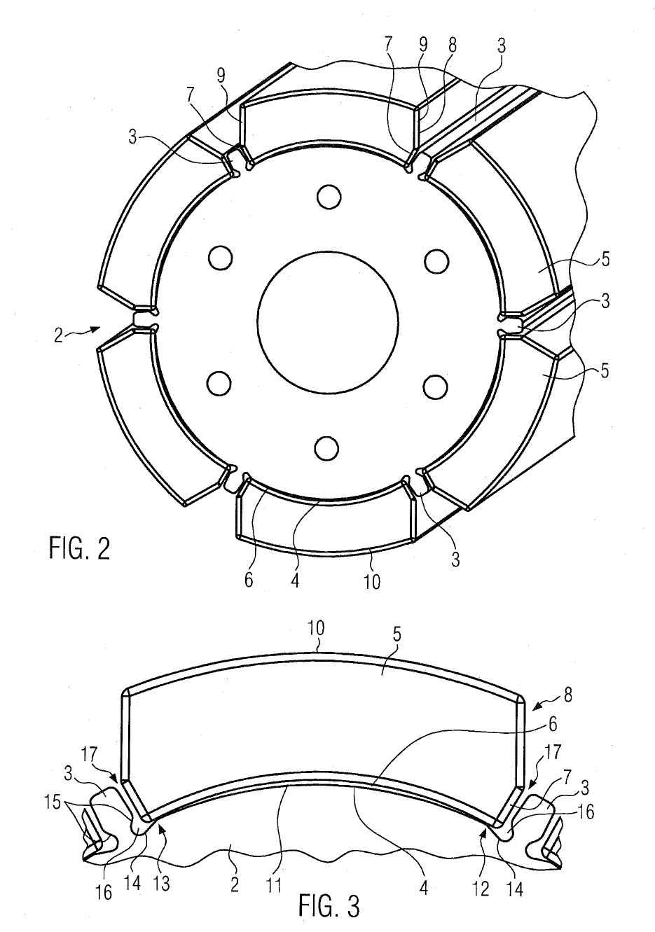

FIG. 2 shows a plan view on the rotor body 2 of FIG. 1. The rotor body 2 has now been equipped with six magnets 5. The magnets 5 are each located between two ribs 3. The magnets 5 rest with their contact face 6 on the receiving face 4 of the rotor body 2. The magnets 5 protrude markedly past the ribs 3. A lower part 7 of a side face 8 of the magnet 5 extends essentially parallel to the rib 3. Approximately at the upper end of the rib 3, the side face 8 merges with an upper part 9, which has an angle of approximately 60 degrees relative to the lower part 7. The upper part 9 of a side face 8 is oriented such that it extends parallel to the upper part 9 of the second side face 8 of the same magnet 5. Thus a notch of approximately 120 degrees is created between two adjacent magnets 5.

The contact face 6 of the magnet 5 extends approximately parallel to the surface 10 of the magnet 5.

In FIG. 2, it can also be seen that the rotor body 2 comprises a lamination packet, which includes a plurality of laminations stacked on one another. The individual laminations of the rotor body 2 are each stamped out. As a result, the costs for producing the rotor body remain the same, even though the contour of the individual lamination has an altered shape, namely ribs 3.

The detail in FIG. 3 shows a magnet 5 that is glued to the rotor body 2. The magnet 5 is located between two adjacent ribs 3. It can be seen clearly that the contact face 6 of the magnet 5 has a different radius of curvature from the receiving face 4 of the rotor body 2. The result is a gap 11 between the contact face 6 and the receiving face 4. The magnet 5 itself rests with its contact face 6 on the receiving face 4 of the rotor body 2 only on the right and left peripheral regions 12, 13. As a result, rocking or wobbling of the magnet 5 on the rotor body 2 is prevented.

The gap 11 between the rotor body 2 and the magnet 5 serves to receive an adhesive, for gluing the magnet 5 to the rotor body 2.

The receiving face 4 of the rotor body 2 has one depression 14 in each of the peripheral regions 12, 13. The depression 14 merges with a taper 15 of the rib 3. This creates a void 16, which is suitable for receiving excess adhesive.

If the magnet 5 is sharp-edged at its lower edge or not completely free of burrs, then the protruding burr can be received in the void 16. Thus magnets can be positioned almost regardless of the nature of their edges.

Between the lower part 7 of the side faces 8 and the rib 3, a spacing 17 forms, which can likewise be filled with adhesive. On the one hand, excess adhesive can flow into it, and on the other, the rib 3 can also be painted with adhesive, so that the spacing 17 is filled, and the magnet is glued laterally as well between two adjacent ribs 3. Alternatively, it is possible for no spacing to be provided between the ribs 3 and the magnet, so that the magnet can be clipped into place between two adjacent ribs. The spacing 17 furthermore serves to absorb oversizes of the magnets that are due to tolerances.

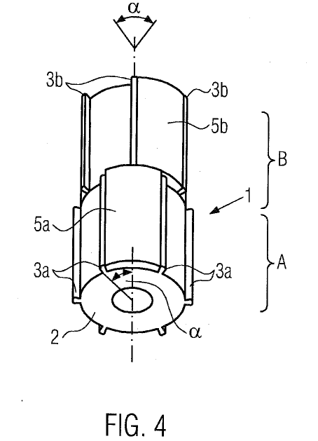

FIG. 4 shows a rotor 1 in a second exemplary embodiment of the invention. As can be seen from FIG. 1, the rotor 1 has a first region A and a second region B. In the first region A, as in the first exemplary embodiment, many ribs 3a are formed, and each two adjacent ribs 3a receive one magnet 5a between them. The second region B is likewise provided with many ribs 3b, and one magnet 5b is located between each two adjacent ribs 3b. The structure of the ribs 3a and 3b is equivalent to the structure shown in the first exemplary embodiment.

As can be seen from FIG. 4, the second region B is offset from the first region A of the rotor by an angle α of approximately 30°. Because of this provision, it is attained that the rotor stops at unwanted detent positions of the electrical machine. This can be attained according to the invention by the easily established offset between the first region A and the second region B of the rotor 2, without requiring beveling of the rotor as in the prior art, for instance.

The rotor of the second exemplary embodiment can be constructed in various ways. On the one hand, it may be produced as a one-piece part with integrally formed ribs 3a and 3b. Alternatively, the rotor 2 can be furnished by means of two separate, shorter rotors that form the regions A and B and upon assembly are merely rotated by the angle α relative to one another. Alternatively, each of the regions A and B of the rotor 2 may also be furnished by a plurality of laminations that are offset in the region B to the region A by the angle α. Otherwise, this exemplary embodiment is equivalent to the preceding exemplary embodiment, so that the description given above for the latter can be referred to.

If the spacing 17 remains available, then the magnet 5 has a certain amount of play between the two ribs 3 that bound it. This play makes both assembly by hand and automated production easier. The axial alignment of the magnet 5 can be done in a simplified way then; the magnet 5 can be more easily displaced as a result of the play relative to the ribs 3.

1. A rotor for an electrical machine, in particular a brushless DC motor, having a rotor body (2) that has a substantially cylindrical shape, and having at least one magnet (5) with a contact face (6), the magnet being disposed on the circumference of the rotor body, characterized in that the rotor body (2) has at least one longitudinally oriented rib (3).

2. The rotor as defined by claim 1, characterized in that the rotor body (2), along its circumference, has at least one receiving face (4) for a magnet (5), the receiving face being laterally defined by two ribs (3).

3. The rotor as defined by claim 1, characterized in that the spacing between two adjacent ribs (3) is somewhat greater than a width of the magnet (5).

4. The rotor as defined by claim 1, characterized in that the magnet (5) can be clipped in place between two adjacent ribs (3).

5. The rotor as defined by claim 1, characterized in that the magnet (5) rests with its contact face (6) on the rotor body (2), substantially at peripheral regions (12, 13) of the rotor body (2), adjacent to the ribs (3).

6. The rotor as defined by claim 2, characterized in that the receiving face (4) of the rotor body (2) has a curvature which differs from the contact face (6) of the magnet (5).

7. The rotor as defined by claim 1, characterized in that the ribs (3) are formed integrally with the rotor body (2).

8. The rotor as defined by claim 1, characterized in that the ribs (3) have a taper (15) on their lower end.

9. The rotor as defined by claim 1, characterized in that the rotor body (2) has one depression (14) in each of the peripheral regions (12, 13).

10. The rotor as defined by claim 1, characterized in that the magnet (5), on a side face (8), has a lower part (7) which extends substantially parallel to the rib (3).

11. The rotor as defined by claim 1, further including a first rotor region (A) having a first rib (3a) and a second rotor region (B) having a second rib (3b) the first rib (3a) is disposed offset by an angle (α) from the second rib (3b) in the circumferential direction of the rotor (2).

12. The rotor as defined by claim 11, characterized in that the first rib (3a) is offset from the second rib (3b) by an angle (α) of between 0.1° and 30°, in particular between 5° and 20°.
